(19) United States
(12) Patent Application Publication
(10) Pub. No.: US 2022/0051232 A1
(43) Pub. Date: Feb. 17, 2022

(54) PAYMENT INFORMATION CORRELATION SYSTEM AND METHOD

(71) Applicant: Charter Communications Operating, LLC, St. Louis, MO (US)

(72) Inventor: David Fergins, Colorado Springs, CO (US)

(73) Assignee: Charter Communications Operating, LLC, St. Louis, MO (US)

(21) Appl. No.: 16/993,490

(22) Filed: Aug. 14, 2020

(51) Int. Cl. G06Q 20/38; G06Q 20/24; G06Q 20/34

(52) U.S. Cl. CPC G06Q 20/38; G06Q 20/34; G06Q 20/24

(57) ABSTRACT

Disclosed herein are payment information correlation systems and methods. A method includes registering, by commercial entities with the system, commercial entity parameter. A consumer registers with the system and selects one or more registered commercial entities. The consumer inputs and saves consumer payment information in a payment information correlation database. The one or more selected registered commercial entities input, responsive to selection, consumer associated commercial entity parameter information. The payment information correlation database correlates for each of the one or more selected registered commercial entities, the consumer payment information with the commercial entity parameter information and the consumer associated commercial entity parameter information. The payment information correlation system automatically updates at appropriate ones of the one or more selected registered commercial entities, the consumer payment information based on at least consumer associated commercial entity parameter information associated with the appropriate ones of the one or more selected registered commercial entities.

### TECHNICAL FIELD

This disclosure relates to consumer information. More specifically, this disclosure relates to a platform for correlating consumer information with commercial entities.

### BACKGROUND

Consumers use credit cards for a variety of onsite and online matters including online banking, purchases, gaming, and ecommerce which involve multiple parties including the consumers, financial entities, commercial entities, and the like. Consumers can change credit cards for a number of reasons including joining a credit card program which offers better perks or if their credit card information is lost or stolen. For example, each transaction and the involved entities are subject to malicious hackers who try to abscond with a consumer's financial information to make unauthorized transactions. The consumers then have to go through time consuming and cumbersome tasks of obtaining a new credit card and updating the credit card information with each entity that may be affected. For example, lack of timely updates for recurring or automatic payments can result in late payment fees, subscription cancellations, product returns. All of these can negatively affect a consumer's credit score ratings. In addition, the commercial entities have to spend time, effort, and expense to correct any issues and collect any outstanding payments.

### SUMMARY

Disclosed herein are payment information correlation systems and methods.

In implementations, a method for correlating payment information between consumers and commercial entities includes registering, by one or more commercial entities with a payment information correlation system, commercial entity parameter information via a commercial entity payment information correlation interface, registering, by a consumer with the payment information correlation system, via a consumer payment information correlation interface, selecting, by the consumer, one or more registered commercial entities via the consumer payment information correlation interface, inputting, by the consumer, consumer payment information via the consumer payment information correlation interface, saving, by the payment information correlation database, the consumer payment information, inputting, by one or more selected registered commercial entities responsive to selection of the commercial entity, consumer associated commercial entity parameter information via respective commercial entity payment information correlation interfaces, correlating, by a payment information correlation database for each of the one or more selected registered commercial entities, the consumer payment information with the commercial entity parameter information and the consumer associated commercial entity parameter information, and automatically updating, by the payment information correlation system at appropriate ones of the one or more selected registered commercial entities, the consumer payment information based on at least consumer associated commercial entity parameter information associated with the appropriate ones of the one or more selected registered commercial entities.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example architecture of a network in accordance with embodiments of this disclosure.

FIG. 2 is a diagram of an example consumer input interface in accordance with embodiments of this disclosure.

FIG. 3 is a diagram of an example commercial entity input interface in accordance with embodiments of this disclosure.

FIG. 4 is a diagram of an example architecture of a network in accordance with embodiments of this disclosure.

FIG. 5 is a diagram of an example device in accordance with embodiments of this disclosure.

FIG. 6 is a flowchart of an example method for payment information correlation in accordance with embodiments of this disclosure.

### DETAILED DESCRIPTION

Reference will now be made in greater detail to embodiments of the invention, examples of which are illustrated in the accompanying drawings. Wherever possible, the same reference numerals will be used throughout the drawings and the description to refer to the same or like parts.

As used herein, the terminology “computer”, “computing device”, or “computing platform” includes any unit, or combination of units, in a distributive platform, centralized platform, or combinations thereof, capable of performing any method, or any portion or portions thereof, disclosed herein. For example, the “computer” or “computing device” may include at least one or more processor(s).

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks or activities. For example, applications may perform one or more functions including, but not limited to, telephony, web browsers, e-commerce transactions, media players, streaming, Internet Protocol (IP) video, travel scheduling and management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, compositions and methods. Those of ordinary skill may thus recognize that other elements and/or steps may be desirable or necessary to implement the devices, systems, compositions and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein are payment information correlation systems and methods. The system provides a mechanism for correlating consumer payment information with multiple commercial entities, where each of the commercial entities can be updated on an on-going basis to ensure correctness and validity of the consumer payment information. The consumer payment information can be credit card information, for example. Consequently, each of the commercial entities is automatically and directly updated by the system in the event of a hack or loss of the consumer payment information upon initiation by the consumer (when the consumer determines an issue) or confirmation by the consumer (when the system alerts the consumer of an issue). This saves the consumer time, effort, and money. In addition, the commercial entities can save on legal and collection fees, and generate timely revenue.

In implementations, the system can include a consumer interface for entry of consumer payment information and selection of commercial entities, and a commercial entity interface for setting commercial parameters associated with the consumer payment information. In implementations, the system can send messages to the selected commercial entities to set the commercial parameters. In implementations, the commercial entities can poll the system at defined time intervals for consumer payment information. Once the consumer payment information and the commercial entities are correlated, updated consumer payment information can be automatically sent to the commercial entities. In implementations, the updates can be at defined intervals.

In implementations, the consumer interface can be used to securely connect with financial entities, card registry systems, or the like to obtain newly-acquired credit card information so that the system can then update the consumer payment information in the system. The system can then update the correlated commercial entities with the updated consumer payment information. In implementations, the consumer can initiate updates via the consumer interface. In implementations, the system can automatically receive updated consumer payment information from correlated financial entities if updates were initially updated by the consumer or upon consumer confirmation when initiated by the system, correlated commercial entities, or correlated financial entities. The consumers can trigger updates via the system or the correlated financial entities.

The system enables maintaining and bolstering a positive ecommerce-based relationship between the commercial entities and consumers. The system holds and secures very little information about the commercial entities or consumers using its services.

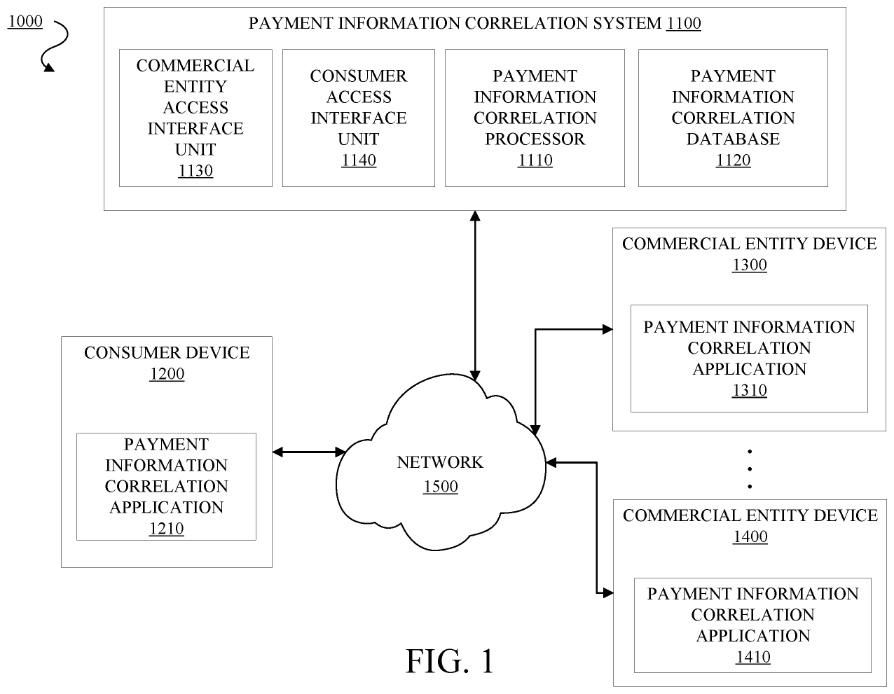

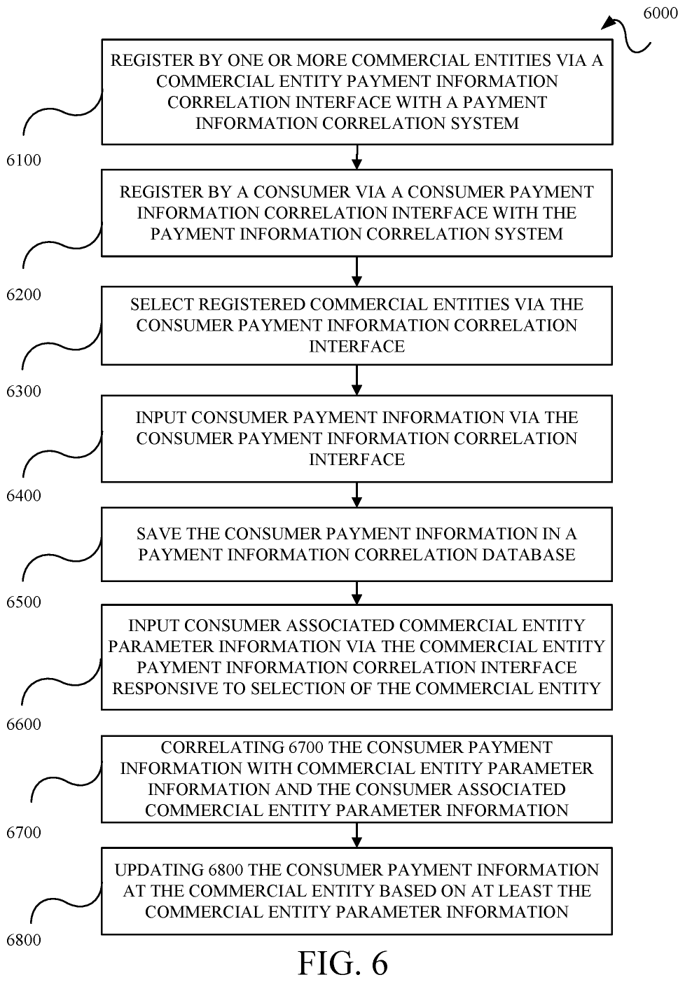

FIG. 1 is a diagram of an example architecture of a system 1000 in accordance with embodiments of this disclosure. In implementations, the system 1000 can include a payment information correlation system 1100 connected to or in communication with (collectively “connected to”) a consumer device 1200, and one or more commercial entity devices 1300 and 1400 via a network 1500. In an implementation, the system 1000 may execute the techniques described in FIG. 6. The connections between the payment information correlation system 1100, the consumer device 1200 and the one or more commercial entity devices 1300 can be established following authentication and authorization techniques as supplemented herein. The system 1000 and the components therein may include other elements which may be desirable or necessary to implement the devices, systems, compositions, and methods described herein. However, because such elements and steps are well known in the art, and because they do not facilitate a better understanding of the disclosed embodiments, a discussion of such elements and steps may not be provided herein.

The payment information correlation system 1100 can be a cloud-based platform, distributed computing platform, and the like. The payment information correlation system 1100 can include a payment information correlation processor 1110, a payment information correlation database 1120, a commercial entity access interface unit 1130, and a consumer access interface unit 1140. The consumer access interface unit 1140 can interface with the consumer device 1200 to receive consumer payment information and make available the consumer payment information to components or elements of the payment information correlation system 1100. The commercial entity access interface unit 1130 can interface with the commercial entity device 1300 to receive commercial entity parameter information and make available the commercial entity parameter information to components or elements of the payment information correlation system 1100. The payment information correlation processor 1110 can interface with the commercial entity access interface unit 1130 and the consumer access interface unit 1140 to execute correlation of the consumer payment information and the commercial entity parameter information at the payment information correlation database 1120. The payment information correlation database 1120 can hold and correlate the consumer payment information and the commercial entity parameter information. In implementations, updates to the consumer payment information, the commercial entity parameter information, or combinations thereof can be executed cooperatively between the payment information correlation processor 1110, the payment information correlation database 1120, the commercial entity access interface unit 1130, and the consumer access interface unit 1140 upon receiving the updated consumer payment information and/or the commercial entity parameter information from the consumer device 1200 and the commercial entity device 1300, respectively.

The consumer device 1200 can be, but is not limited to, end user devices, information appliances, mobile computers, laptops, handheld computers, personal media devices, smartphones, notebooks, notepads, tablets and the like. In implementations, the consumer device 1200 can include, but not limited to, a payment information correlation application 1210 and the like to connect to the payment information correlation system 1100 and/or the consumer access interface unit 1140. In implementations, a consumer can access the payment information correlation system 1100 and/or the consumer access interface unit 1140 via a Web interface on the consumer device 1200.

The one or more commercial entity devices 1300 and 1400 can be, but are not limited to, commercial entity based end user devices, information appliances, mobile computers, laptops, handheld computers, personal media devices, smartphones, notebooks, notepads, tablets and the like. In implementations, the one or more commercial entity devices 1300 and 1400 can include, but not limited to, a payment information correlation application 1310 and 1410 and the like to connect to the payment information correlation system 1100 and/or the commercial entity access interface unit 1130. The commercial entities can be retail stores, online services, restaurants, subscription services, and the like.

The network 1500 can be and can include, but is not limited to, the Internet, an intranet, a local area network (LAN), a wide area network (WAN), a public network, a private network, a cellular network, a WiFi-based network, a telephone network, a landline network, public switched telephone network (PSTN), a wireless network, a wired network, a private branch exchange (PBX), an Integrated Services Digital Network (ISDN), a IP Multimedia Services (IMS) network, a Voice over Internet Protocol (VoIP) network, an IP network, cable, satellite, hybrid coaxial systems, fiberoptic systems, 5G, autonomous vehicle parking, and like including any combinations thereof. In an implementation, the network 1500 may contain one or more servers, network elements or devices, and the like.

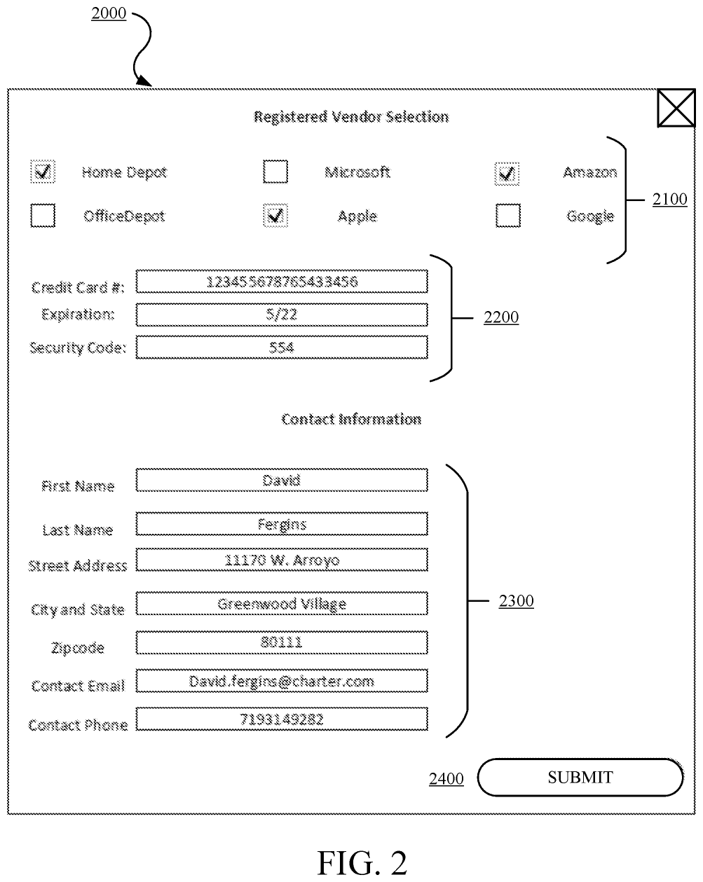

FIG. 2 is a diagram of an example consumer input interface 2000 for inputting consumer payment information in accordance with embodiments of this disclosure. In implementations, the consumer input interface 2000 can be presented when accessing the payment information correlation application 1210 on the consumer device 1200. The consumer input interface 2000 can include, but is not limited to, a vendor selection area 2100, a credit card information input area 2200, a consumer contact information area 2300, and a submit button 2400. The consumer can select one or more commercial entities in the vendor selection area 2100, where each selected commercial entity is correlated and updated with the consumer payment information. The consumer can enter the credit card information in the credit card information input area 2200. The consumer can enter contact information in consumer contact information area 2300. In implementations, the consumer input interface 2000 can have a credit card information input area 2200 for each selected commercial entity in the event different credit cards are to be used for different commercial entities. Upon entry of the required information, the consumer can select or click on the submit button 2400.

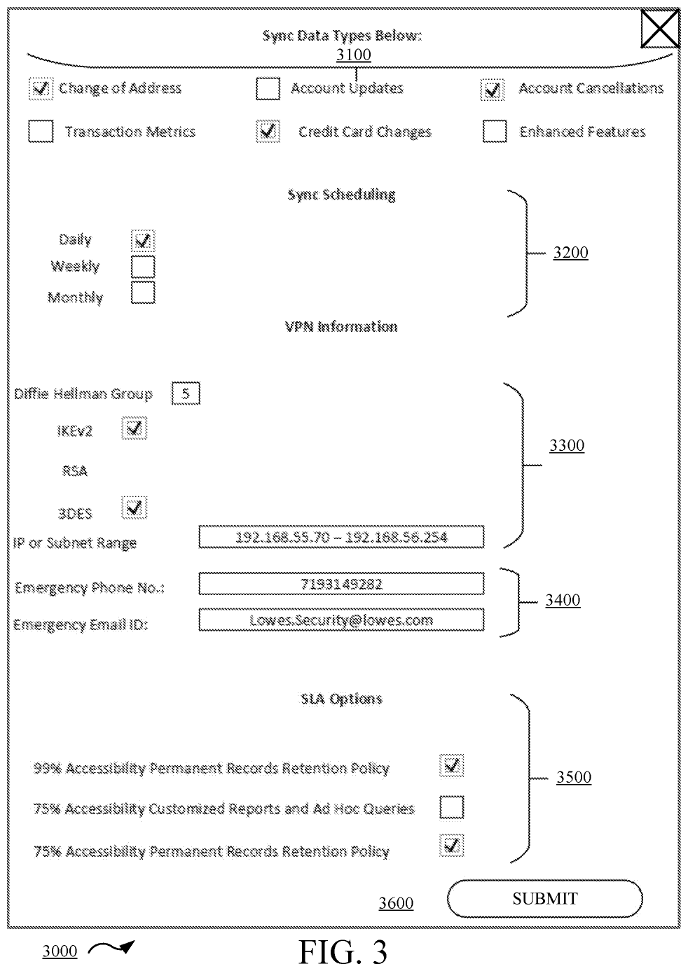

FIG. 3 is a diagram of an example commercial entity input interface 3000 for inputting commercial entity parameters in accordance with embodiments of this disclosure. In implementations, the commercial entity input interface 3000 can be presented when accessing the payment information correlation application 1310 and/or 1410 on the commercial entity device 1300 and/or commercial entity device 1400, respectively. The commercial entity input interface 3000 can include, but is not limited to, a synchronization input area 3100, a synchronization scheduling input area 3200, a connectivity input area 3300, a commercial entity contact information input area 3400, a service level agreement (SLA) options input area 3500, and a submit button 3600. The commercial entity can select which data types need to be synced for each consumer in the synchronization input area 3100. The data types can include, but are not limited to, change of address, account updates, account cancellations, transaction metrics, credit card changes, and enhanced features. The commercial entity can select a synchronization schedule for a consumer in the synchronization scheduling input area 3200. The synchronization schedule can include, daily, weekly, monthly, and the like. The commercial entity can set connection configuration parameters in the connectivity input area 3300. For example, the connection configuration parameters can include, but are not limited to, public-private key exchange, authentication parameters, encryption parameters, Internet Protocol (IP) address range, and the like. The commercial entity can set options for SLA levels in the SLA options input area 3500. Upon entry of the required information, the commercial entity can select or click on the submit button 3600.

Operationally, with respect to FIGS. 1-3, a consumer or user can register or enroll with the payment information correlation system 1100 using the payment information correlation application 1210 provisioned on the consumer device 1200. In implementations, the payment information correlation application 1210 interacts with the consumer access interface unit 1140. The consumer can then enter consumer payment information using the payment information correlation application 1210. In implementations, commercial entities registered in the payment information correlation system 1100 are presented in the consumer input interface. The consumer access interface unit 1140 and the payment information correlation processor 1110 save the consumer payment information in the payment information correlation database 1120.

The payment information correlation processor 1110 and the commercial entity access interface unit 1130 send messages to the designated commercial entities that a consumer has registered and input consumer payment information with the payment information correlation system 1100. The commercial entities can then set the commercial entity parameters for the consumer using the payment information correlation application 1310 and/or 1410 provisioned on the commercial entity devices 1300 and/or 1400, respectively. In implementations, commercial entity parameters can be set at registration and set as the default for all consumers. The commercial entity access interface unit 1130 and the payment information correlation processor 1110 save the commercial entity parameters in the payment information correlation database 1120.

The payment information correlation processor 1110 and the payment information correlation database 1120 correlate the consumer payment information and the commercial entity parameters and save the correlated information in the payment information correlation database 1120. Defined portions of the correlated information can be sent to the consumer and commercial entities indicating successful correlation. The payment information correlation system 1100 updates the consumer payment information at the commercial entity based on the commercial entity parameters. In implementations, the payment information correlation system 1100 updates the consumer payment information at the commercial entity based on a consumer update.

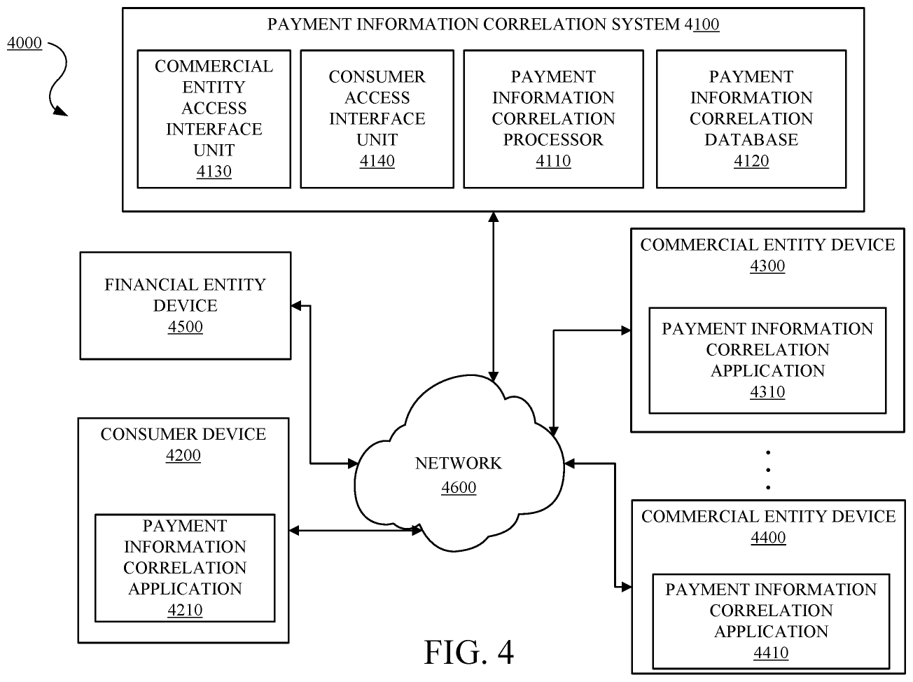

FIG. 4 is a diagram of an example architecture of a system 4000 in accordance with embodiments of this disclosure. In implementations, the system 4000 can include a payment information correlation system 4100 connected to or in communication with (collectively “connected to”) a consumer device 4200 and one or more commercial entity devices 4300 and 4400 via a network 4600. The consumer device 4200 can be connected to a financial entity device 4500. In an implementation, the system 4000 may execute the techniques described in FIG. 6. The connections between the payment information correlation system 4100, the consumer device 4200, the one or more commercial entity devices 4300 and the financial entity device 4500 can be established following authentication and authorization techniques as supplemented herein. The system 4000 and the components therein may include other elements which may be desirable or necessary to implement the devices, systems, compositions, and methods described herein. However, because such elements and steps are well known in the art, and because they do not facilitate a better understanding of the disclosed embodiments, a discussion of such elements and steps may not be provided herein.

The payment information correlation system 4100 can be a cloud-based platform, distributed computing platform, and the like. The payment information correlation system 4100 can include a payment information correlation processor 4110, a payment information correlation database 4120, a commercial entity access interface unit 4130, and a consumer access interface unit 4140. The consumer access interface unit 4140 can interface with the consumer device 4200 to receive consumer payment information and make available the consumer payment information to components or elements of the payment information correlation system 4100. The commercial entity access interface unit 4130 can interface with the commercial entity device 4300 to receive commercial entity parameter information and make available the commercial entity information to components or elements of the payment information correlation system 4100. The payment information correlation processor 4110 can interface with the commercial entity access interface unit 4130 and the consumer access interface unit 4140 to execute correlation of the consumer payment information and the commercial entity parameter information at the payment information correlation database 4120. The payment information correlation database 4120 can hold and correlate the consumer payment information and the commercial entity parameter information. In implementations, updates to the consumer payment information, the commercial entity parameter information, or combinations thereof can be executed cooperatively between the payment information correlation processor 4110, the payment information correlation database 4120, the commercial entity access interface unit 4130, and the consumer access interface unit 4140 upon receiving the updated consumer payment information and/or the commercial entity parameter information from the consumer device 4200 and the commercial entity device 4300, respectively.

The consumer device 4200 can be, but is not limited to, end user devices, information appliances, mobile computers, laptops, handheld computers, personal media devices, smartphones, notebooks, notepads, tablets and the like. In implementations, the consumer device 4200 can include, but not limited to, a payment information correlation application 4210 and the like to connect to the payment information correlation system 4100, the consumer access interface unit 4140, and/or the financial entity device 4500. In implementations, a consumer can access the payment information correlation system 4100 and/or the consumer access interface unit 4140 via a Web interface on the consumer device 4200.

The one or more commercial entity devices 4300 and 4400 can be, but are not limited to, commercial entity based end user devices, information appliances, mobile computers, laptops, handheld computers, personal media devices, smartphones, notebooks, notepads, tablets and the like. In implementations, the one or more commercial entity devices 4300 and 4400 can include, but not limited to, a payment information correlation application 4310 and 4410 and the like to connect to the payment information correlation system 4100 and/or the commercial entity access interface unit 4130.

The financial entity device 4500 can be, but are not limited to, financial entity based end user devices, information appliances, mobile computers, laptops, handheld computers, personal media devices, smartphones, notebooks, notepads, tablets and the like. In implementations, the financial entity device 4500 can be credit card registries, banks, credit card providers, and the like.

The network 4600 can be and can include, but is not limited to, the Internet, an intranet, a local area network (LAN), a wide area network (WAN), a public network, a private network, a cellular network, a WiFi-based network, a telephone network, a landline network, public switched telephone network (PSTN), a wireless network, a wired network, a private branch exchange (PBX), an Integrated Services Digital Network (ISDN), a IP Multimedia Services (IMS) network, a Voice over Internet Protocol (VoIP) network, an IP network, cable, satellite, hybrid coaxial systems, fiberoptic systems, 5G, autonomous vehicle parking, and like including any combinations thereof. In an implementation, the network 4600 may contain one or more servers, network elements or devices, and the like.

Operationally, with respect to FIGS. 2-4, a consumer or user can register or enroll with the payment information correlation system 4100 using the payment information correlation application 4210 provisioned on the consumer device 4200 or via secure well-known web browser. In implementations, the payment information correlation application 4210 interacts with the consumer access interface unit 4140. The consumer can then enter consumer payment information using the payment information correlation application 4210. In implementations, commercial entities registered in the payment information correlation system 4100 are presented in the consumer input interface. The consumer access interface unit 4140 and the payment information correlation processor 4110 save the consumer payment information in the payment information correlation database 4120. In implementations, the payment information correlation application 4210 can include an interface to financial entities and can connect to a financial entity device such as financial entity device 4500 to automatically update the consumer payment information due to a lost, stolen, expired, or otherwise non-functional credit card, debit card, and the like. In implementations, financial entities registered with the payment information correlation system 4100 are presented in the consumer input interface.

The payment information correlation processor 4110 and the commercial entity access interface unit 4130 send messages to the designated commercial entities that a consumer has registered and input consumer payment information with the payment information correlation system 4100. The commercial entities can then set the commercial entity parameters for the consumer using the payment information correlation application 4310 and/or 4410 provisioned on the commercial entity devices 4300 and/or 4400, respectively. In implementations, commercial entity parameters can be set at registration and set as the default for all consumers. The commercial entity access interface unit 4130 and the payment information correlation processor 4110 save the commercial entity parameters in the payment information correlation database 4120.

The payment information correlation processor 4110 and the payment information correlation database 4120 correlate the consumer payment information and the commercial entity parameters and save the correlated information in the payment information correlation database 4120. Defined portions of the correlated information can be sent to the consumer and commercial entities indicating successful correlation. The payment information correlation system 4100 updates the consumer payment information at the commercial entity based on the commercial entity parameters. In implementations, the payment information correlation system 4100 updates the consumer payment information at the commercial entity based on a consumer update. In implementations, the payment information correlation system 4100 updates the consumer payment information at the commercial entity based on an event, where the financial entity updates upon consumer confirmation or approval, via the financial entity device, the consumer payment information at the payment information correlation application 4210 which in turn updates the consumer payment information at the commercial entity. The event can be, for example, reporting of a stolen, lost, expired, or otherwise non-functional card associated with the consumer payment information.

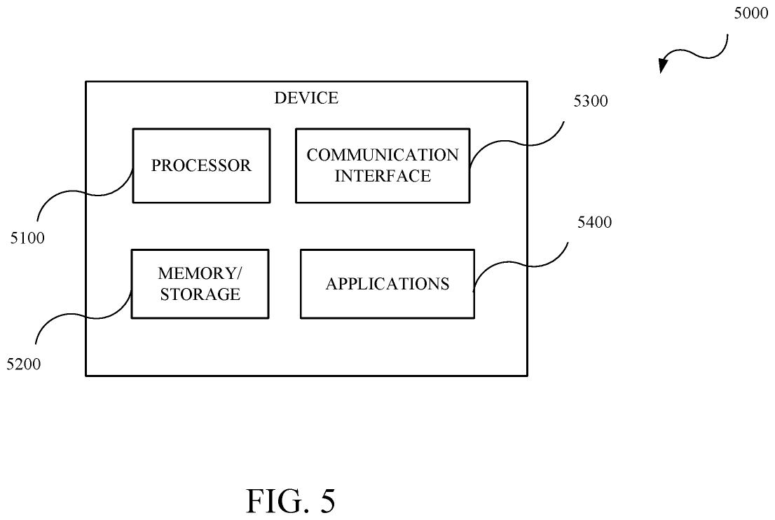

FIG. 5 is a block diagram of an example of a device 5000 in accordance with embodiments of this disclosure. The device 5000 may include, but is not limited to, a processor 5100, a memory/storage 5200, a communication interface 5300, and applications 5400. The device 5000 may include or implement, for example, the payment information correlation system 1100, the consumer device 1200, the and one or more commercial entity devices 1300 and 1400, the payment information correlation processor 1110, the payment information correlation database 1120, the commercial entity access interface unit 1130, the consumer access interface unit 1140, the payment information correlation system 4100, the consumer device 4200, the one or more commercial entity devices 4300 and 4400, the financial entity device 4500, the payment information correlation processor 4110, the payment information correlation database 4120, the commercial entity access interface unit 4130, and the consumer access interface unit 4140. In an implementation, the memory/storage 5200 may store consumer payment information, the commercial entity parameter settings, the correlated information, the financial entity information, and the like. The applications 5400 can include the payment information correlation application 1210, the payment information correlation applications 1310 and 1410, the payment information correlation application 4210, and the payment information correlation application 4310 and 4410. The input, selection, and update techniques or methods described herein may be stored in the memory/storage 5200 and executed by the processor 5100 in cooperation with the memory/storage 5200, the communications interface 5300, and applications 5400, as appropriate. The device 5000 may include other elements which may be desirable or necessary to implement the devices, systems, compositions and methods described herein. However, because such elements and steps are well known in the art, and because they do not facilitate a better understanding of the disclosed embodiments, a discussion of such elements and steps may not be provided herein.

FIG. 6 is a flowchart of an example method 6000 in accordance with embodiments of this disclosure. The method 6000 includes: registering 6100 by one or more commercial entities via a commercial entity payment information correlation interface with a payment information correlation system; registering 6200 by a consumer via a consumer payment information correlation interface with the payment information correlation system; selecting 6300 registered commercial entities via the consumer payment information correlation interface; inputting 6400 consumer payment information via the consumer payment information correlation interface; saving 6500 the consumer payment information in a payment information correlation database; inputting 6600 consumer associated commercial entity parameter information via the commercial entity payment information correlation interface responsive to selection of the commercial entity; correlating 6700 the consumer payment information with commercial entity parameter information and the consumer associated commercial entity parameter information; and updating 6800 the consumer payment information at the commercial entity based on at least the commercial entity parameter information. For example, the technique 6000 may be implemented, as applicable and appropriate, by the payment information correlation system 1100, the consumer device 1200, the and one or more commercial entity devices 1300 and 1400, the payment information correlation processor 1110, the payment information correlation database 1120, the commercial entity access interface unit 1130, the consumer access interface unit 1140, the payment information correlation system 4100, the consumer device 4200, the one or more commercial entity devices 4300 and 4400, the financial entity device 4500, the payment information correlation processor 4110, the payment information correlation database 4120, the commercial entity access interface unit 4130, the consumer access interface unit 4140, the processor 5100, the memory/storage 5200, the communication interface 5300, and the applications 5400.

The method 6000 includes registering 6100 by one or more commercial entities via a commercial entity payment information correlation interface with a payment information correlation system. Access to consumer payment information is available to registered participants in the payment information correlation system. The commercial entity can exchange application programming interface (API) settings and set commercial entity parameters such as communication protocols, virtual private network (VPN) criterion, database schemas, enclave compulsory compliance mandates, authentication protocols, encryption protocols, authorization protocols, and the like. In implementations, one or more financial entities can register with the payment information correlation system.

The method 6000 includes registering 6200 by a consumer via a consumer payment information correlation interface with the payment information correlation system. A customer connects to and establishes an account with a payment information correlation service via the payment information correlation system.

The method 6000 includes selecting 6300 registered commercial entities via the consumer payment information correlation interface. The customer selects, for example, commercial entities with which the customer has subscriptions, does online shopping from, and the like and which are registered with the payment information correlation system. For example, the commercial entities can include Amazon®, NetFlix®, gym, meal services, and the like. The customer selects by checking a box associated with each respective business on the payment information correlation interface. In implementations, the consumer can select registered financial entities.

The method 6000 includes inputting 6400 consumer payment information via the consumer payment information correlation interface. The customer inputs consumer payment information such as credit card information, contact information, and the like via the payment information correlation interface. In implementations, multiple credit card information can be input. In implementations, different credit card information can be input for different commercial entities. In implementations, the consumer can select registered commercial entities and connect them with one or more of the financial entities for purposes of consumer initiated or approved updates.

The method 6000 includes saving 6500 the consumer payment information in a payment information correlation database. The consumer payment information is saved in the payment information correlation database. A unique identifier is generated for the consumer payment information. For example, a key-value pair (KVP) can be generated for the consumer payment information. The payment information correlation database complies with industry best practice standards and mandates.

The method 6000 includes inputting 6600 consumer associated commercial entity parameter information via the commercial entity payment information correlation interface responsive to selection of the commercial entity. The consumer associated commercial entity parameter information can include which consumer data is to be updated, what polling interval to use, and the like.

The method 6000 includes correlating 6700 the consumer payment information with commercial entity parameter information and the consumer associated commercial entity parameter information. The database joins the consumer payment information, the commercial entity parameter information, and the consumer associated commercial entity parameter information to generate correlated information. In implementations, a correlation identifier is generated for the correlated information. In implementations, the correlation identifier can be used when updating the consumer payment information from a consumer driven event or when polling from a commercial entity. In implementations, selected financial entities are correlated.

The method 6000 includes updating 6800 the consumer payment information at the commercial entity based on at least the consumer associated commercial entity parameter information. The commercial entity can poll the payment information correlation system at a defined interval to ensure correctness and validity of the consumer payment information. In implementations, the updating can be event driven when the consumer updates the consumer payment information due to credit card issues associated with the consumer payment information. In implementations, an update of the consumer payment information can fail or be unsuccessful. In this instance, a message can be sent to the consumer and each affected commercial entity. In implementations, updates can be sent by selected financial entities upon consumer approval or confirmation.

In general, a method for correlating payment information between consumers and commercial entities, the method includes registering, by one or more commercial entities with a payment information correlation system, commercial entity parameter information via a commercial entity payment information correlation interface, registering, by a consumer with the payment information correlation system, via a consumer payment information correlation interface, selecting, by the consumer, one or more registered commercial entities via the consumer payment information correlation interface, inputting, by the consumer, consumer payment information via the consumer payment information correlation interface, saving, by the payment information correlation database, the consumer payment information, inputting, by one or more selected registered commercial entities responsive to selection of the commercial entity, consumer associated commercial entity parameter information via respective commercial entity payment information correlation interfaces, correlating, by a payment information correlation database for each of the one or more selected registered commercial entities, the consumer payment information with the commercial entity parameter information and the consumer associated commercial entity parameter information, and automatically updating, by the payment information correlation system at appropriate ones of the one or more selected registered commercial entities, the consumer payment information based on at least consumer associated commercial entity parameter information associated with the appropriate ones of the one or more selected registered commercial entities. In implementations, the consumer associated commercial entity parameter information includes a synchronization interval and the updating is performed at the synchronization interval. In implementations, the updating is performed due to a consumer driven event. In implementations, the method further includes generating a unique identifier for the consumer payment information. In implementations, the method further includes sending, to the one or more selected registered commercial entities, an indicator of inputted consumer payment information. In implementations, the consumer payment information includes credit card information and contact information. In implementations, the method further includes registering, by the consumer with at least one financial entity, via the consumer payment information correlation interface. In implementations, the method further includes updating, by the at least one financial entity, the consumer payment information based on changes to the credit card information upon consumer approval. In implementations, the method further includes triggering an update of the consumer payment information at appropriate ones of the one or more selected registered commercial entities.

In general, a payment information correlation system includes a commercial entity access interface unit configured to receive commercial entity registration information, a consumer access interface unit configured to receive consumer payment information and commercial entity designations, a payment information correlation database, and a payment information correlation processor connected to the commercial entity access interface unit, the consumer access interface unit, and the payment information correlation database, the payment information correlation processor and the payment information correlation database, for each designated commercial entity, configured to correlate the commercial entity registration information, the consumer payment information, and the commercial entity designations, save correlated information in the payment information correlation database, and update the consumer payment information at the designated commercial entity based on a polling interval provided in the commercial entity registration information. In implementations, the payment information correlation processor configured to message each designated commercial entity. In implementations, the consumer payment information includes credit card information and contact information. In implementations, the payment information correlation processor and the payment information correlation database, for each designated commercial entity, further configured to update the consumer payment information based on updated consumer payment information received via the consumer access interface unit.

In general, a method for payment information correlation between consumers and commercial entities, the method includes receiving, from a consumer at a payment platform, one or more registered commercial entities, receiving, from the consumer at the payment platform, at least credit card information, sending, by the payment platform, indicators to each selected commercial entity, receiving, from each selected commercial entity, commercial entity parameter information, correlating, by the payment platform for each selected registered commercial entity, the credit card information with the commercial entity parameter information, and automatically updating, by the payment platform at each commercial entity, the credit card information based on the commercial entity parameter information for each commercial entity. In implementations, wherein the commercial entity parameter information includes an updating interval. In implementations, the method further includes receiving updated credit card information at the payment platform. In implementations, the method further includes triggering an update in response to receipt of updated credit card information at the payment platform. In implementations, the method further includes receiving, from one or more commercial entities, registration information including at least communication protocols, security protocols, and authentication protocols. In implementations, the method further includes receiving, by the payment platform, an indication of a failed credit card confirmation. In implementations, the method further includes sending, by the payment platform, an indication of the failed credit card confirmation to the consumer and each commercial entity associated with the failed credit card confirmation.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, solid state drive (SSD), or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

1. A non-transitory computer readable medium storing instructions operable to cause one or more processors to perform operations comprising:
registering, by one or more commercial entities with a payment information correlation system, commercial entity parameter information via a commercial entity payment information correlation interface;
registering, by a consumer with the payment information correlation system, via a consumer payment information correlation interface;
selecting, by the consumer, one or more registered commercial entities via the consumer payment information correlation interface with which the consumer has done transactions;
inputting, by the consumer, consumer payment information via the consumer payment information correlation interface;
saving, by a payment information correlation database, the consumer payment information;
inputting, by one or more selected registered commercial entities responsive to selection of the commercial entity, consumer associated commercial entity parameter information via respective commercial entity payment information correlation interfaces;
correlating, by the payment information correlation database for each of the one or more selected registered commercial entities, by joining the consumer payment information with the commercial entity parameter information and the consumer associated commercial entity parameter information; and
automatically updating, by the payment information correlation system at appropriate ones of the one or more selected registered commercial entities, the consumer payment information based on at least consumer associated commercial entity parameter information associated with the appropriate ones of the one or more selected registered commercial entities.

2. The non-transitory computer readable medium of claim 1, wherein the consumer associated commercial entity parameter information includes a synchronization interval and further storing instructions operable to cause one or more processors to perform operations comprising:
is performed at the synchronization interval.

3. The non-transitory computer readable medium of claim 2, wherein the updating is performed due to a consumer driven event.

4. The non-transitory computer readable medium of claim 1, further storing instructions operable to cause one or more processors to perform operations comprising:
generating a unique identifier for the consumer payment information.

5. The non-transitory computer readable medium of claim 4, further storing instructions operable to cause one or more processors to perform operations comprising:
sending, to the one or more selected registered commercial entities, an indicator of inputted consumer payment information.

6. The non-transitory computer readable medium of claim 1, wherein the consumer payment information includes credit card information and contact information.

7. The non-transitory computer readable medium of claim 6, further storing instructions operable to cause one or more processors to perform operations comprising:
registering, by the consumer with at least one financial entity, via the consumer payment information correlation interface.

8. The non-transitory computer readable medium of claim 7, further storing instructions operable to cause one or more processors to perform operations comprising:
updating, by the at least one financial entity, the consumer payment information based on changes to the credit card information upon consumer approval.

9. The non-transitory computer readable medium of claim 8, further storing instructions operable to cause one or more processors to perform operations comprising:
triggering an update of the consumer payment information at appropriate ones of the one or more selected registered commercial entities.

10. (canceled)

11. (canceled)

12. (canceled)

13. (canceled)

14. A computer readable medium having computer readable instructions stored thereon that, when executed by a processing device cause the processing device to perform operations comprising:
registering, by one or more commercial entities with a payment platform, commercial entity parameter information via a commercial entity payment information correlation interface;
receiving, from a consumer at the payment platform, one or more registered commercial entities for which the consumer has done transactions;
receiving, from the consumer at the payment platform, at least credit card information;
sending, by the payment platform, indicators to each selected commercial entity;
receiving, from each selected commercial entity, commercial entity parameter information;
correlating by a join, by the payment platform for each selected registered commercial entity, the credit card information with the commercial entity parameter information; and
automatically updating, by the payment platform at each commercial entity, the credit card information based on the commercial entity parameter information for each commercial entity.

15. The computer readable medium of claim 14, wherein the commercial entity parameter information includes an updating interval.

16. The computer readable medium of claim 14, further having computer readable instructions stored thereon that, when executed by a processing device cause the processing device to perform operations comprising:
receiving updated credit card information at the payment platform.

17. The computer readable medium of claim 16, further having computer readable instructions stored thereon that, when executed by a processing device cause the processing device to perform operations comprising:
triggering an update in response to receipt of updated credit card information at the payment platform.

18. The computer readable medium of claim 14, further having computer readable instructions stored thereon that, when executed by a processing device cause the processing device to perform operations comprising:
receiving, from one or more commercial entities, registration information including at least communication protocols, security protocols, and authentication protocols.

19. The computer readable medium of claim 14, further having computer readable instructions stored thereon that, when executed by a processing device cause the processing device to perform operations comprising:
receiving, by the payment platform, an indication of a failed credit card confirmation.

20. The computer readable medium of claim 19, further having computer readable instructions stored thereon that, when executed by a processing device cause the processing device to perform operations comprising:
sending, by the payment platform, an indication of the failed credit card confirmation to the consumer and each commercial entity associated with the failed credit card confirmation.
